(19) United States
(12) Patent Application Publication
(10) Pub. No.: US 2013/0071199 A1
(43) Pub. Date: Mar. 21, 2013

(54) WORKPIECE CLAMPING DEVICE OF ENGRAVING MACHINE

(71) Applicant: Bor-Yann CHUANG, Taichung City (TW)

(72) Inventor: Bor-Yann CHUANG, Taichung City (TW)

(21) Appl. No.: 13/238,066

(22) Filed: Sep. 21, 2011

(51) Int. Cl. B23Q 3/06

(52) U.S. Cl. 409/225

(57) ABSTRACT

A workpiece clamping device of an engraving machine is mounted on a workbench of the engraving machine. The workbench has a stop portion and a slide groove. The workpiece clamping device includes a slide member which is slidable along slide groove, a fixing member inserted through the slide member, and a holding member which is obliquely disposed on the slide member. When in use, the workpiece is placed on the workbench and one side of the workpiece is against the stop portion. The slide member is slid to lean against the other side of the workpiece. Through the fixing member, the slide member is secured on the workbench. The holding member is operated to hold against the workpiece. The workpiece can be secured on the workbench quickly.

### BACKGROUND OF THE INVENTION

1. Field of the Invention

The present invention relates to a workpiece clamping device of an engraving machine.

2. Description of the Prior Art

An engraving machine is used to engrave character, pattern, figure or the like on a workpeice. As shown in FIG. 1 and FIG. 2, a conventional engraving machine 200 comprises a workbench 201 and a grantry post 202 above the workbench 201. The grantry post 202 is provided with a tool head 203 which is slidable on the grantry post 202. A graver 204 is secured to the tool head 203. When in use, the workpiece 300 is placed on the workbench 201 and engraved by the engraving machine 200.

Referring to FIG. 1 and FIG. 2, in order to secure the workpiece 300 on the workbench 201 for the engraving machine 200 to engrave, the surface of the workbench 201 has a stop portion 205 and a plurality of parallel slide grooves 206 for a press plate 400 to slide thereon. The stop portion 205 can be a protruding edge extending from the workbench 201. In this embodiment, the stop portion 205 is a stop rib. Each slide groove 206 has two opposing side walls 207 and a bottom wall 208 connected between the two side walls 207. At least one of the side walls 207 has a limit portion 209. The limit portion 209 can be a protruding block. The press plate 400 has a plate body 401. The plate body 401 has an elongate hole 402 and a threaded hole 403. A fixing bolt 404 is provided in the elongate hole 402. The fixing bolt 404 has a head 405 which is located between the bottom wall 208 and the limit portion 209 to be confined in the slide groove 206. The fixing bolt 404 further has a tail end 406 which is exposed out of the elongate hole 402 and connected with a nut 407. An adjustment bolt 408 is provided in the threaded hole 403. Thus, when in use, the workpiece 300 is placed on the workbench 201 and one side of the workpiece 300 is against the stop portion 205. After that, the plate body 401 of the press plate 400 is used to hold against the other side of the workpiece 300, and the adjustment bolt 408 is adjusted for the plate body 401 to be parallel to the workpiece 300. Finally, the nut 407 is fastened to fix the workpiece 300 on the workbench 201.

Though the workpiece 300 can be fixed on the workbench 201 in this way, it is necessary to continuously adjust the adjustment bolt 408 and the fixing bolt 404 during operation. This is inconvenient and takes a lot of time to fix the workpiece 300. In particular, when the workpiece 300 is large in size, it is necessary to use several press plates 400 to fix the workpiece 300. This consumes much time and labor. Besides, the press plate 400 only presses the surface of the workpiece 300. During the operation of the engraving machine 200, the workpiece 300 may move unexpectedly due to vibration of the motor to influence precision of processing. Accordingly, the inventor of the present invention has devoted himself based on his many years of practical experiences to solve these problems.

### SUMMARY OF THE INVENTION

The primary object of the present invention is to provide a workpiece clamping device of an engraving machine for the user to clamp a workpiece conveniently and quickly.

In order to achieve the aforesaid object, the workpiece clamping device is mounted on a workbench of the engraving machine. The workbench has at least one stop portion and at least one slide groove. The slide groove has two opposing side walls and a bottom wall connected between the two side walls. At least one of the side walls of the slide groove has a limit portion. The workpiece clamping device comprises a slide member, a fixing member, and a holding member. The slide member is slidable along the slide groove of the workbench. The slide member has a front side relative to the axial direction of the slide groove and a rear side opposite to the front side. The slide member further has an upright through hole toward the workbench. The through hole communicates with the slide groove. The slide member further has a threaded hole which is obliquely disposed relative to the workbench. The threaded hole slants downward toward the front side. The fixing member is inserted in the through hole. One end of the fixing member extends out of the through hole to be in the slide groove and has a fixing portion. The fixing portion is confined between the bottom wall of the slide groove and the limit portion. Another end of the fixing member extends out of the through hole and has an enlarged adjustment portion. A distance defined between the adjustment portion and the fixing portion is adjustable to clamp the slide member on the workbench. The holding member is screwed in the threaded hole. The holding member has a holding portion at one end thereof toward the front side of the slide member. The holding portion extends out of the threaded hole and located in front of the slide member. The holding member has an operation portion at another end thereof toward the rear side of the slide member. The holding member is rotatable in the threaded hole to adjust a distance that the holding portion extends out of the threaded hole.

When in use, the workpiece is direct placed on the workbench, one side of the workpiece is against the stop portion. The slide member is slid to have the front side against the other side of the workpiece. The adjustment portion of the fixing member is adjusted and cooperated with the fixing portion to clamp the slide member on the workbench. Finally, the operation portion of the holding member is operated with the holding portion to lean against the workpiece. The workpiece can be secured on the workbench quickly. The present invention can be operated conveniently and quickly to enhance work efficiency.

### BRIEF DESCRIPTION OF THE DRAWINGS

FIG. 1 is a perspective view of a conventional engraving machine;

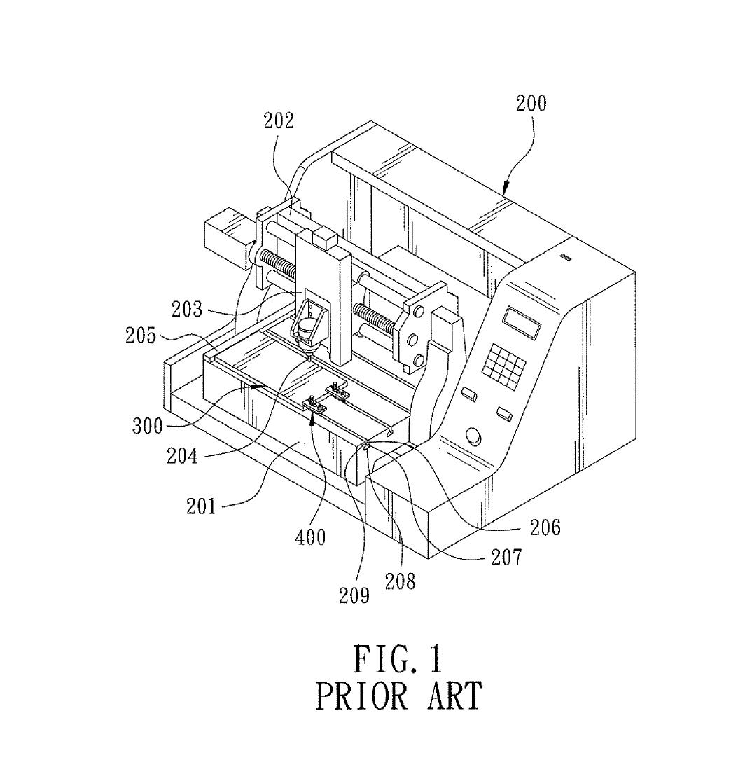

FIG. 2 is an enlarged sectional view of the conventional engraving machine;

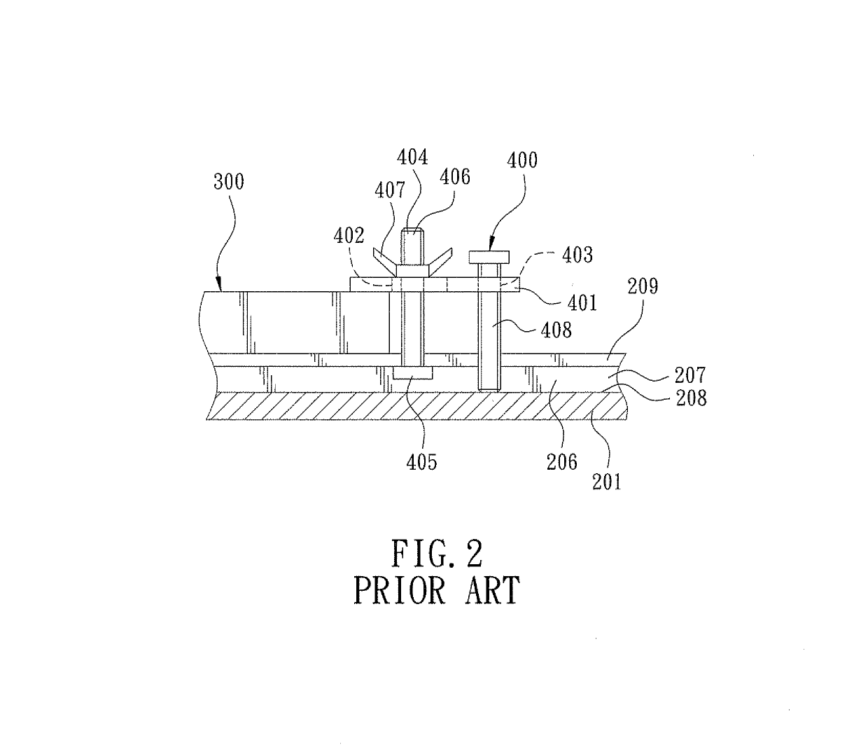

FIG. 3 is a perspective view according to a preferred embodiment of the present invention;

FIG. 4 is an exploded view according to the preferred embodiment of the present invention;

FIG. 5 is a side view according to the preferred embodiment of the present invention;

FIG. 6 is a sectional view according to the preferred embodiment of the present invention; and

FIG. 7 is a schematic view of the preferred embodiment of the present invention when in use.

### DETAILED DESCRIPTION OF THE PREFERRED EMBODIMENTS

Embodiments of the present invention will now be described, by way of example only, with reference to the accompanying drawings.

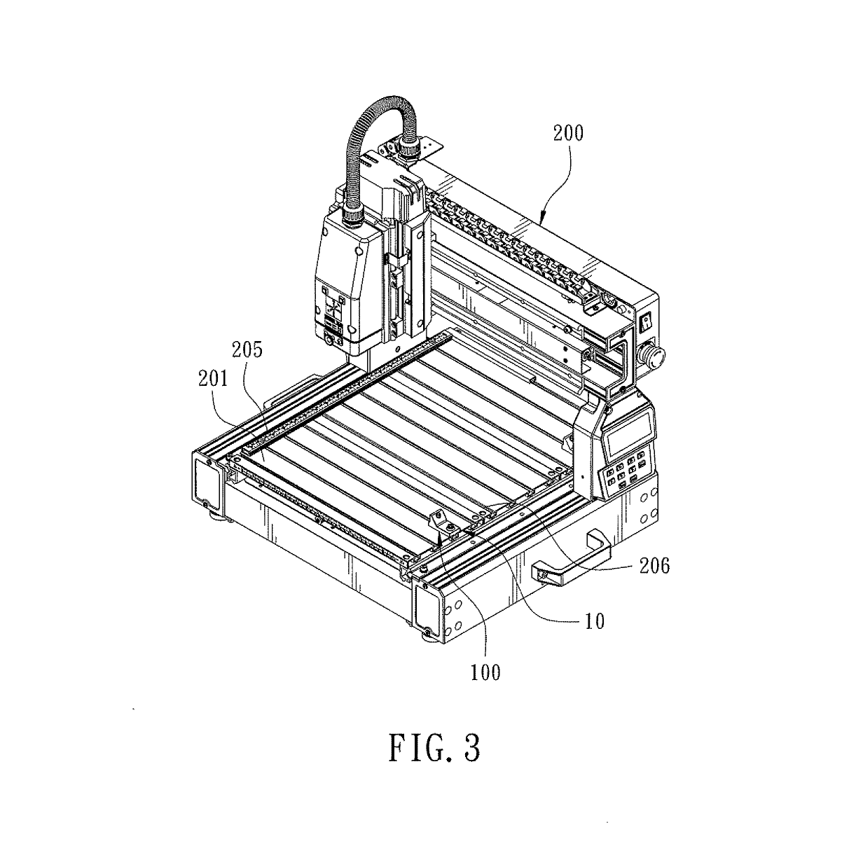

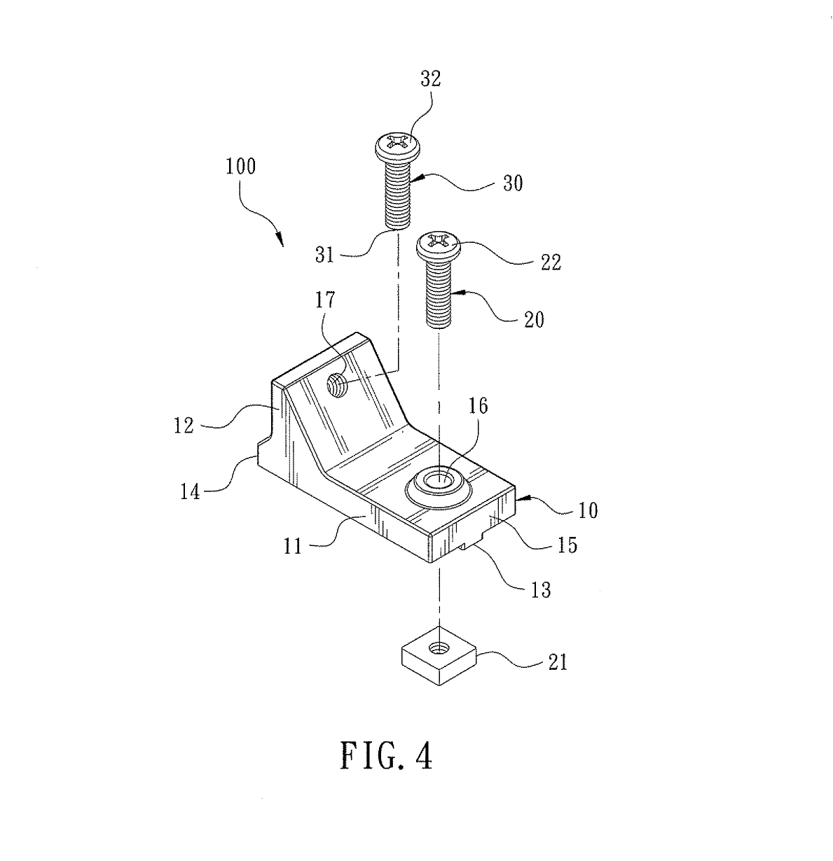

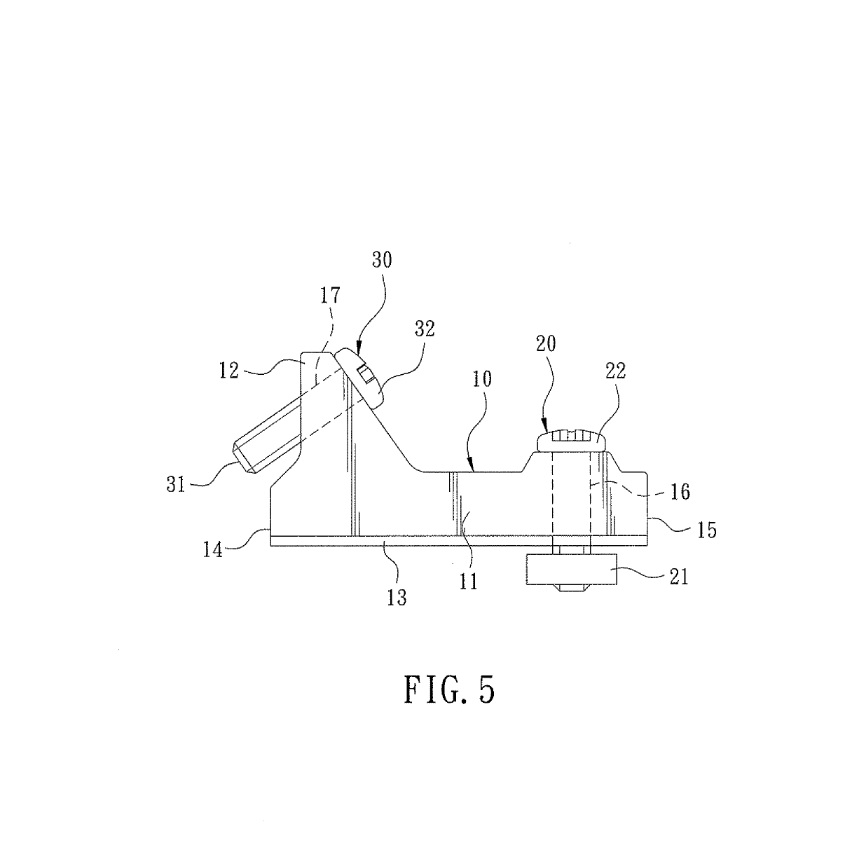

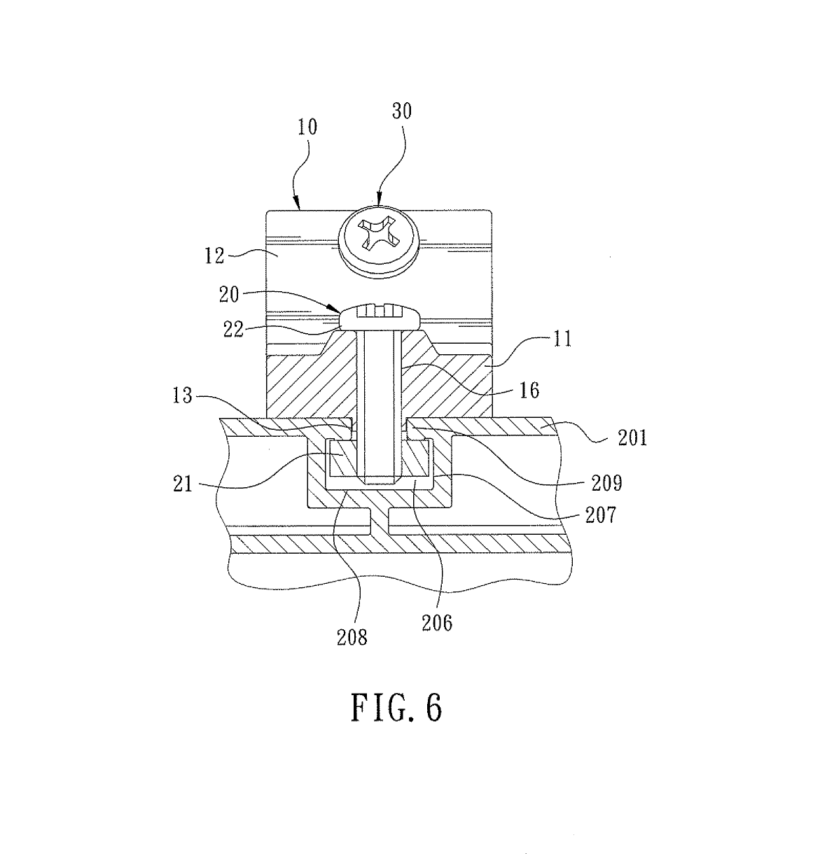

As shown in FIG. 3 through FIG. 6, a workpiece clamping device 100 according to a preferred embodiment of the present invention is mounted on an engraving machine 200. The engraving machine 200 as the prior art comprises a workbench 201. The workbench 201 has at least one stop portion 205 and at least one slide groove 206. In this embodiment, the workbench 201 has one stop portion 205 which is a stop rib. The workbench 201 further has a plurality of parallel slide grooves 206. Each slide groove 206 has two opposing side walls 207 and a bottom wall 208 connected between the two side walls 207. At least one of the two side walls 207 has a limit portion 209. In this embodiment, each of the two side walls 207 has a limit portion 209. The limit portion 209 is a protruding block. The workpiece clamping device 100 comprises a slide member 10, a fixing member 20, and a holding member 30.

The slide member 10 has a main body 11 which is slidable along the slide groove 206. The main body 11 has a protrusion 12 protruding from a top thereof and a limit protrusion 13 protruding from a bottom thereof. The limit protrusion 13 is in a strip shape and corresponds in position to the slide groove 206. The limit protrusion 13 is located in the slide groove 206, so that the main body 11 can slide axially along the slide groove 206. The slide member 10 has a front side 14 relative to the axial direction of the slide groove 206 and a rear side 15 opposite to the front side 14. The slide member 10 further has an upright through hole 16 toward the workbench 201. The through hole 16 communicates with the slide groove 206. The slide member 10 further has a threaded hole 17 which is obliquely disposed relative to the workbench 201. The threaded hole 17 slants downward toward the front side 14. In this embodiment, the threaded hole 17 is defined in the protrusion 12. The central axis of the threaded hole 17 is tilted at an angle of about 45 relative to the workbench 201.

The fixing member 20 is inserted in the through hole 16. One end of the fixing member 20 extends out of the through hole 16 to be in the slide groove 206 and has a fixing portion 21. The fixing portion 21 is confined between the bottom wall 208 of the slide groove 206 and the limit portion 209. Another end of the fixing member 20 also extends out of the through hole 16 and has an enlarged adjustment portion 22. The distance between the adjustment portion 22 and the fixing portion 21 is adjustable for the slide member 10 to be clamped on the workbench 201. In this embodiment, the fixing member 20 is a screw inserted in the through hole 16. The head of the screw is exposed out of the through hole 16 to form the adjustment portion 22. The fixing portion 21 is a nut screwed at the tail end of the screw.

The holding member 30 is screwed in the threaded hole 17. The holding member 30 has a holding portion 31 at one end thereof toward the front side 14. The holding member 30 has an operation portion 32 at another end thereof toward the rear side 15. The holding member 30 can be turned in the threaded hole 17 to adjust the distance that the holding portion 31 extends out of the threaded hole 17. In this embodiment, the holding member 30 is a screw.

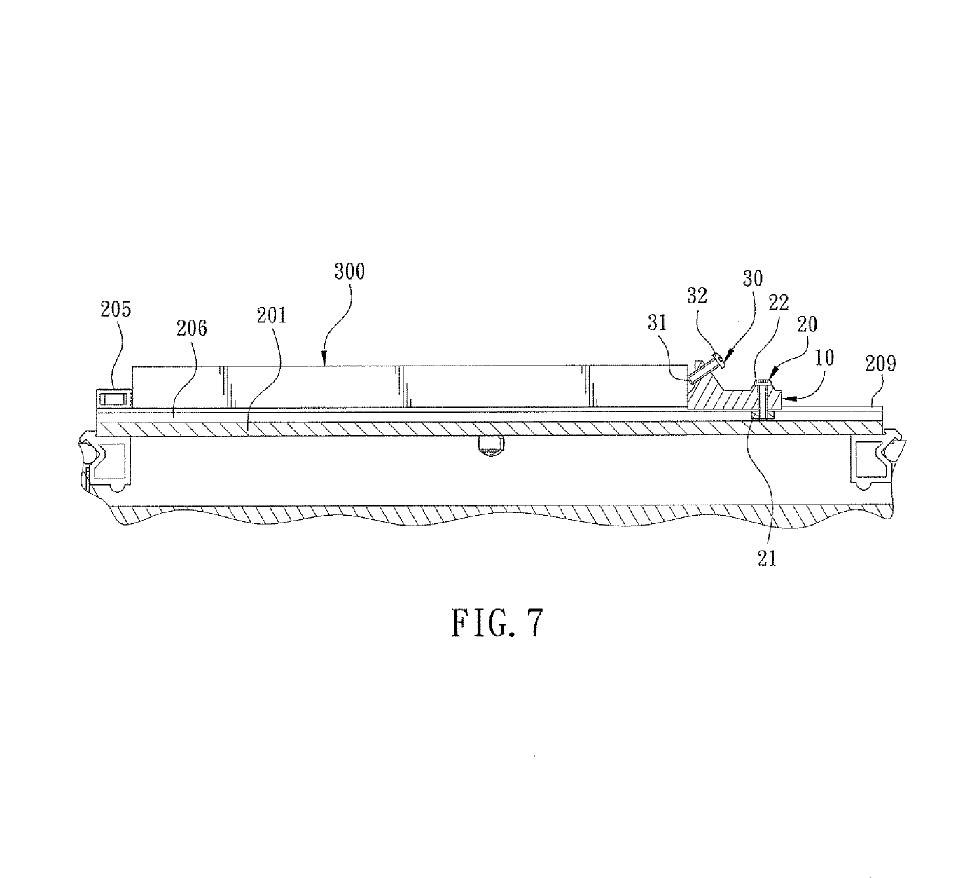

FIG. 7 is a schematic view of the preferred embodiment of the present invention when in use. When the user wants the workpiece 300 secured on the workbench 201, the workpiece 300 is placed on the workbench 201. One side of the workpiece 300 is against the stop portion 205. The slide member 10 is slid to have the front side 14 against the other side of the workpiece 300. The adjustment portion 22 of the fixing member 20 is adjusted and cooperated with the fixing portion 21 to clamp the slide member 10 on the workbench 201. Finally, the operation portion 32 of the holding member 30 is operated with the holding portion 31 to lean against the workpiece 300, so that the workpiece 300 is held between the stop portion 209 and the front side 14 of the slide member 10. Compared to the prior art, the workpiece clamping device 100 of the present invention can secure the workpiece 300 quickly. The present invention can be operated conveniently to enhance work efficiency.

It is noted that the holding portion 31 of the holding member 30 is tilted at an angle of 45 to hold against the workpiece 300 and to provide a force obliquely applied to the workpiece 300. In this way, the workpiece 300 can be secured on the workbench 201 exactly, preventing the workpiece 300 from being moved unexpectedly.

It is noted that the user can first secure one workpiece clamping device 100 on the workbench 201, and then the workpiece 300 is placed on the workbench 201 with one side of the workpiece 300 against the workpiece clamping device 100. After that, another workpiece clamping device 100 is provided at the other side of the workpiece 300. The workpiece 300 is clamped tightly by the two workpiece clamping devices 100.

Furthermore, the threaded hole 17 is disposed in the protrusion 12, which is convenient for the user to operate the holding member 30.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A workpiece clamping device of an engraving machine, mounted on a workbench of the engraving machine, the workbench having at least one stop portion and at least one slide groove, the slide groove having two opposing side walls and a bottom wall connected between the two side walls, at least one of the side walls of the slide groove having a limit portion, the workpiece clamping device comprising:
a slide member slidable along the slide groove of the workbench, the slide member having a front side relative to an axial direction of the slide groove and a rear side opposite to the front side, the slide member further having an upright through hole toward the workbench, the through hole communicating with the slide groove, the slide member further having a threaded hole which is obliquely disposed relative to the workbench, the threaded hole slanting downward toward the front side;
a fixing member inserted in the through hole, one end of the fixing member extending out of the through hole to be in the slide groove and having a fixing portion, the fixing portion being confined between the bottom wall of the slide groove and the limit portion, another end of the fixing member extending out of the through hole and having an enlarged adjustment portion, a distance defined between the adjustment portion and the fixing portion being adjustable for the slide member to be clamped on the workbench; and
a holding member screwed in the threaded hole, the holding member having a holding portion at one end thereof toward the front side of the slide member, the holding portion extending out of the threaded hole and located in front of the slide member, the holding member having an operation portion at another end thereof toward the rear side of the slide member, the holding member being rotatable in the threaded hole to adjust a distance that the holding portion extends out of the threaded hole.

2. The workpiece clamping device of an engraving machine as claimed in claim 1, wherein the slide member has a main body, the main body having a protrusion protruding from a top thereof, the threaded hole being defined in the protrusion.

3. The workpiece clamping device of an engraving machine as claimed in claim 1, wherein the slide member has a main body, the main body having a limit protrusion protruding from a bottom thereof, the limit protrusion being in a strip shape and corresponding in position to the slide groove, the limit protrusion being located in the slide groove so that the main body is slidable along the slide groove.

4. The workpiece clamping device of an engraving machine as claimed in claim 1, wherein the threaded hole has a central axis which is tilted at an angle of 45 relative to the workbench.

5. The workpiece clamping device of an engraving machine as claimed in claim 1, wherein the fixing member is a screw inserted in the through hole, the screw having a head exposed out of the through hole to form the adjustment portion, the fixing portion being a nut screwed at a tail end of the screw.

6. The workpiece clamping device of an engraving machine as claimed in claim 1, wherein the holding member is a screw.
